(19) United States
(12) Patent Application Publication
(10) Pub. No.: US 2015/0095177 A1
(43) Pub. Date: Apr. 2, 2015

(54) METHOD AND APPARATUS FOR PROVIDING SUBSCRIBER ELIGIBILITY VERIFICATION USING COMMUNITY VALIDATION

(71) Applicant: Adobe Systems Incorporated, San Jose, CA (US)

(72) Inventors: Ajay Jain, Ghazlabad (IN); Sanjeev Kumar Biswas, Bangalore (IN)

(73) Assignee: Adobe Systems Incorporated, San Jose, CA (US)

(21) Appl. No.: 14/043,342

(22) Filed: Oct. 1, 2013

(51) Int. Cl. G06Q 30/06; G06F 9/44; G06F 17/30

(52) U.S. Cl. CPC G06Q 30/0609; G06F 17/30; G06F 8/71; G06Q 30/0605
USPC 705/26.2

(57) ABSTRACT

A computer implemented method and apparatus for providing subscriber eligibility verification using community validation. The method comprises: receiving credentials to verify a user as eligible to be a member of a group; matching the credentials to member information of a plurality of verified members of the group; requesting a reference from a plurality of matched verified members of the group, verifying that the user is eligible to be a member of the group; and validating the user as a member of the group upon receipt of at least one of the requested references.

### BACKGROUND

1. Field of the Invention

Embodiments of the present invention generally relate to subscription verification services and, more particularly, to a method and apparatus for providing subscriber eligibility verification using community validation.

2. Description of the Related Art

Software manufacturers often offer discounted prices for special segments of users. For example, ADOBE System Incorporated often offers teachers and students discounted prices for software products. Part of the purchase process is to verify that the user is in fact, a teacher or a student, and therefore eligible for discounted prices. The eligibility verification process is often performed by third-party verification services that are very costly to the software manufacturers. In addition, providing credentials such as ID cards presents a number of undesirable issues. For example, an ID card that is scanned and uploaded during use, may be damaged or unclear resulting in a delay in the verification process. In addition, ID cards may be manipulated before they are scanned in order to falsely identify a purchaser as a member of the special segment for which the discounted price applies.

Therefore, there is a need for a method and apparatus for providing subscriber eligibility verification using community validation.

### SUMMARY

A method and apparatus for providing subscriber eligibility verification using community validation is provided. The method receives credentials from a user. The credentials are used to verify that the user is a member of a group. The credentials are matched to member information of a plurality of verified members of the group. A request is sent requesting a reference from a plurality of matched verified members of the group, verifying that the user is eligible to be a member of the group. Upon receipt of at least one of the requested verifications, the user is validated as a member of the group.

The Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a block diagram of a system for providing subscriber eligibility verification using community validation, according to one or more embodiments;

FIG. 2 depicts a flow diagram of a method for providing member eligibility verification using community validation, as performed by the verification module, email module, and approval tracker of FIG. 1, according to one or more embodiments; and

FIG. 3 depicts a flow diagram of a method for providing subscriber eligibility verification using community validation, as performed by the verification module, email module, and approval tracker of FIG. 1, according to one or more embodiments.

While the method and apparatus is described herein by way of example for several embodiments and illustrative drawings, those skilled in the art will recognize that the method and apparatus for providing subscriber eligibility verification using community validation is not limited to the embodiments or drawings described. It should be understood, that the drawings and detailed description thereto are not intended to limit embodiments to the particular form disclosed. Rather, the intention is to cover all modifications, equivalents and alternatives falling within the spirit and scope of the method and apparatus for providing subscriber eligibility verification using community validation defined by the appended claims. Any headings used herein are for organizational purposes only and are not meant to limit the scope of the description or the claims. As used herein, the word “may” is used in a permissive sense (i.e., meaning having the potential to), rather than the mandatory sense (i.e., meaning must). Similarly, the words “include”, “including”, and “includes” mean including, but not limited to. Additionally, the word “subscriber” means a user who purchases use of a software application.

### DETAILED DESCRIPTION OF EMBODIMENTS

Embodiments of the present invention include a method and apparatus for providing subscriber eligibility verification using community validation. The embodiments maintain a master database of previously verified and subscribed members. One or more previously verified members of a user's community provide a reference on behalf of the user. The reference is used to verify that the user is a member of the community eligible for a special subscription price. The user selects a plurality of previously verified members who can act as a reference. When a predefined number of previously verified members provide the required reference, the user is considered verified.

Advantageously, the embodiments provide software providers, such as ADOBE Systems Incorporated, as well as providers of hardware that requires special software for operation, an extremely low cost, social driven, automated verification of special category customers.

Various embodiments of a method and apparatus for providing subscriber eligibility verification using community validation are described. In the following detailed description, numerous specific details are set forth to provide a thorough understanding of claimed subject matter. However, it will be understood by those skilled in the art that claimed subject matter may be practiced without these specific details. In other instances, methods, apparatuses or systems that would be known by one of ordinary skill have not been described in detail so as not to obscure claimed subject matter.

Some portions of the detailed description that follow are presented in terms of algorithms or symbolic representations of operations on binary digital signals stored within a memory of a specific apparatus or special purpose computing device or platform. In the context of this particular specification, the term specific apparatus or the like includes a general-purpose computer once it is programmed to perform particular functions pursuant to instructions from program software. Algorithmic descriptions or symbolic representations are examples of techniques used by those of ordinary skill in the signal processing or related arts to convey the substance of their work to others skilled in the art. An algorithm is here, and is generally, considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these or similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

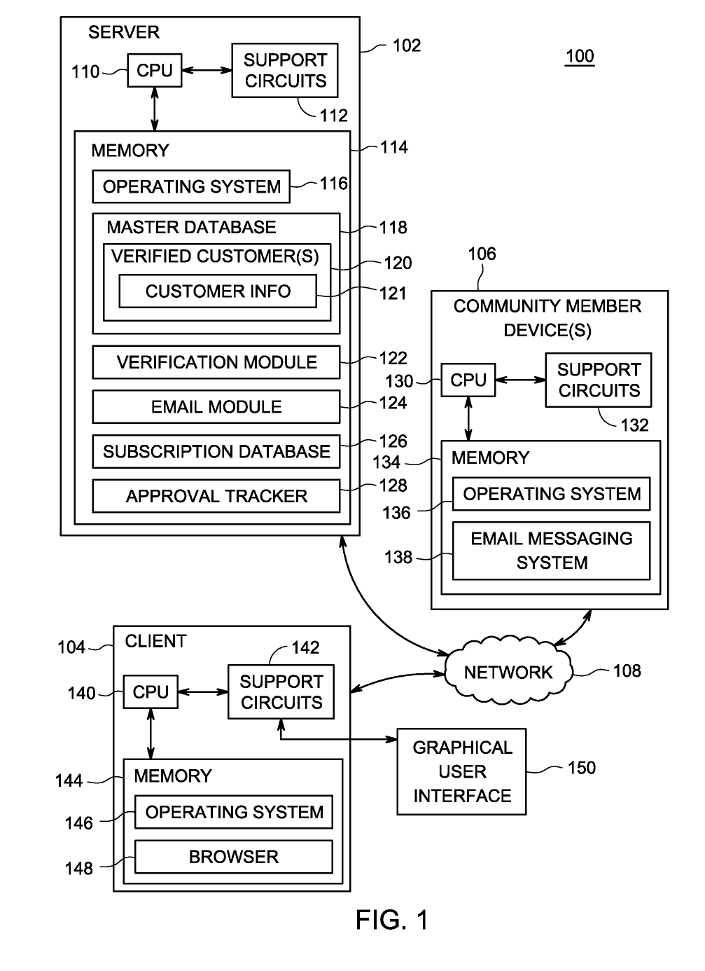

FIG. 1 is a block diagram of an apparatus 100 for providing subscriber eligibility verification using community validation, according to one or more embodiments. The apparatus 100 includes a server 102, a client 104, and a plurality of community member devices 106, communicatively coupled to one another via a network 108. The server 102 is a computing device, such as a desktop computer, laptop, tablet computer, and the like, or the server 102 may be a cloud based server. The server 102 includes a Central Processing Unit (CPU) 110, support circuits 112, and a memory 114. The CPU 110 may include one or more commercially available microprocessors or microcontrollers that facilitate data processing and storage. The various support circuits 112 facilitate the operation of the CPU 110 and include one or more clock circuits, power supplies, cache, input/output circuits, and the like. The memory 114 includes at least one of Read Only Memory (ROM), Random Access Memory (RAM), disk drive storage, optical storage, removable storage and/or the like.

The memory 114 includes an operating system 116, a master database 118, a verification module 122, an email module 124, a subscription database 126, and an approval tracker 128. The master database 118 includes database entries that provide details for a plurality of verified customers 120. Each entry for a verified customer 120 includes customer information 121. The customer information 121 includes at least an email address, as well as verification information that was previously used to verify the customer. The operating system 116 may include various commercially known operating systems. In some embodiments, the subscription database 126 is located remote from the server 102.

The client 104 is a computing device, for example, a desktop computer, laptop, tablet computer, and the like. The client 104 includes or is attached to a graphical user interface 150. The client 104 includes a Central Processing Unit (CPU) 140, support circuits 142, and a memory 144. The CPU 140 may include one or more commercially available microprocessors or microcontrollers that facilitate data processing and storage. The various support circuits 142 facilitate the operation of the CPU 140 and include one or more clock circuits, power supplies, cache, input/output circuits, and the like. The memory 144 includes at least one of Read Only Memory (ROM), Random Access Memory (RAM), disk drive storage, optical storage, removable storage and/or the like.

The memory 144 includes an operating system 146, and a browser 148. The operating system 146 may include various commercially known operating systems. The graphical user interface 150 facilitates communication between the browser 148 and the server 102.

Each community member device 106 is a computing device, for example, a desktop computer, laptop, tablet computer, mobile device, and the like. The community member device 106 includes a Central Processing Unit (CPU) 130, support circuits 132, and a memory 134. The CPU 130 may include one or more commercially available microprocessors or microcontrollers that facilitate data processing and storage. The various support circuits 132 facilitate the operation of the CPU 130 and include one or more clock circuits, power supplies, cache, input/output circuits, and the like. The memory 134 includes at least one of Read Only Memory (ROM), Random Access Memory (RAM), disk drive storage, optical storage, removable storage and/or the like.

The memory 124 includes an operating system 136 and an email messaging system 138 capable of receiving and sending email messages. The operating system 136 may include various commercially known operating systems.

The network 108 includes a communication system that connects computers (or devices) by wire, cable, fiber optic and/or wireless link facilitated by various types of well-known network elements, such as hubs, switches, routers, and the like. The network 108 may be a part of the Intranet using various communications infrastructure, such as Ethernet, Wi-Fi, a personal area network (PAN), a wireless PAN, Bluetooth, Near field communication, and the like.

When a user on the client 104 wishes to purchase a specially priced software product (i.e., a software product that provides a price discount to members of specific groups), the user creates a login to the server 102 of the software provider. Upon successful completion of payment for the purchase, the verification module 122 updates the subscription database 126 to entitle the user to a trial version of the purchased software product. The verification module 122 requests the user to provide credentials that prove that the user is a member of the group that is entitled to the software product at the discounted priced. Upon receipt of the requested credentials, the verification module 122 compares the provided credentials to entries that represent verified customers 120 in the master database 118. The matching entries represent members of the user's community who are already verified as part of the group entitled to the reduced price. The verification module 122 displays matching entries from the master database 118. In some embodiments, the matching entries are provided in two lists; one list of entries for verified customers 120 having customer information 121 that matches all of the criteria entered by the user and a second list of entries for verified customers 120 having customer information 121 that matches less than all of the criteria entered by the user. The user may select one or more entries from each of the lists. The selected entries represent verified customers 120 that the user may know and who can provide a reference that verifies that the user is a member of the group entitled to the discounted price. In some embodiments, a predefined number of entries is required for verification. For example, five references may be required from verified customers matching all of the entered criteria, or ten references from verified customers matching less than all of the entered criteria or some other combination from one or both groups. In other embodiments, the predefined number of entries required for verification can be one.

The email module 124 retrieves email accounts from the master database 118 for each entry selected from the lists and sends an email to each community member device 106 requesting a reference confirmation from community member device 106. The email may include a simple way for the community member device 106 to provide a reference for the user. For example, the email may include a reference confirmation link. The community member device 106 receives the email through their email messaging system 138 and the user of the community member device 106 may choose to respond to the email or choose not to respond. If the user of the community member device 106 responds to the email and provides a reference by, for example, clicking on the reference confirmation link, a notification is sent by email messaging system 138 to the approval tracker 128.

The approval tracker 128 keeps track of the references that are received from the community member devices 106 for a user. When the required number of references is received for the user, the user is considered verified. The approval tracker 128 then updates the subscription database 126 to deactivate the user's trial version of the software product and activate the user's fully operational version of the software product.

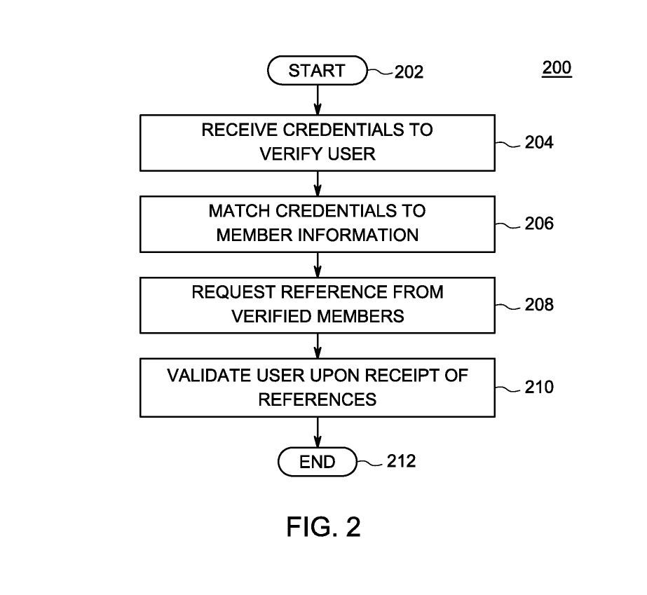

FIG. 2 depicts a flow diagram of a method 200 for providing member eligibility verification using community validation, as performed by the verification module 122, email module 124, and approval tracker 128 of FIG. 1, according to one or more embodiments. The method 200 requests references from members of a community to which a user claims to be a member. Upon receipt of references, the user is verified to be a member of the community. The method 200 starts at step 202 and proceeds to step 204.

At step 204, the method 200 receives credential information regarding a user who claims to be a member of a specific community. For example, the user may claim to be a student at a university, a member of an organization, or a member of any community that is provided special services that the user seeks. The type of credential information required is dependent on the group that is provided the special services. For example, a student at a university may be required to provide a course in which the student is enrolled and a university name. A doctor may be required to provide a name of a hospital in which the doctor has privileges and a department in which the doctor works.

The method 200 proceeds to step 206, where the method 200 matches the received credentials to member information. The method 200 searches a master database of verified members of the user's community to which the user claims membership who have customer information that matches the credentials received regarding the user. Some verified members may have customer information matching all of the credentials received from the user, for example, those verified members who take the same course at the same university as the user. Some verified members may have customer information matching less than all of the credentials received from the user, for example, those already-verified members who do not take the same course as the user, but attend the same university as the user.

The method 200 proceeds to step 208, where the method 200 requests references from verified members retrieved in the search of the master database. In some embodiments, the method 200 displays the entries representing verified members that were retrieved from the master database. In such embodiments, the method 200 receives input from a user who selects a plurality of entries of community members from whom the user wishes to request a reference. In some embodiments, the method 200 automatically selects a pre-defined number of entries representing community members. The method 200 sends each selected community member an email requesting a reference confirmation. The method 200 retrieves an email address for each selected community member from the master database, and generates and sends an email to each selected community member. In some embodiments, the method 200 includes a reference confirmation link in each email such that the recipient of the email may easily provide a reference for the user by merely selecting the reference confirmation link. In other embodiments, other methods of reference confirmation may be used.

The method 200 proceeds to step 210, where the method 200 validates a user upon receipt of references. The method 200 receives references from verified community members. When a predetermined number of references are received, the user is considered validated. The method 200 adds the user to the master database of verified members. The method 200 proceeds to step 212 and ends.

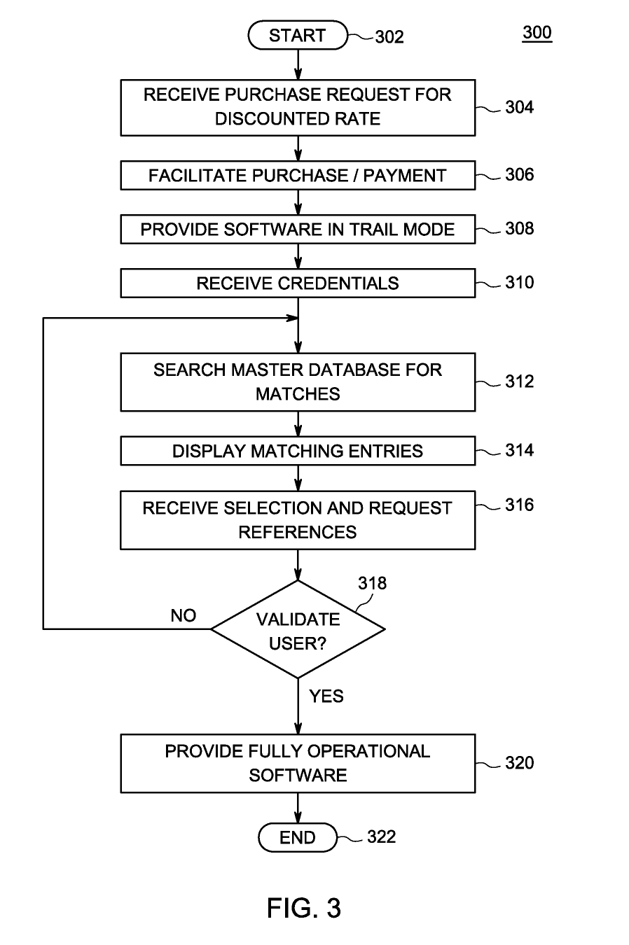

FIG. 3 depicts a flow diagram of a method 300 for providing subscriber eligibility verification using community validation, as performed by the verification module 122, email module 124, and approval tracker 128 of FIG. 1, according to one or more embodiments. The method 300 provides a user with a trial version of a software product and verifies a user's credential via a community validation. Upon successful community validation, the method 300 provides the user with the fully operational version of the software product. The method 300 starts at step 302 and proceeds to step 304.

At step 304, the method 300 receives a purchase request for a price-differentiated offering. For example, the request may come from a university student who wishes to purchase PHOTOSHOP® at a student price. The method 300 proceeds to step 306, where the method 300 facilitates payment for the requested product.

The method 300 proceeds to step 308, where the method 300 updates a subscription database to provide the user with a trial version of the software product. The user has access to the trial version of the software product until the method 300 verifies the user's eligibility to the reduced price via community validation.

The method 300 proceeds to step 310, where the method 300 receives credentials from the user. The type of credential information required is dependent on the group that is provided the reduced price. For example, if the reduced price is for students, the method 300 may request a course title or number in which the user is enrolled, a university name where the user is enrolled, and an address for the university.

The method 300 proceeds to step 312, where the method 300 searches a master database of verified customers to find members of the user's community who have customer information that matches the credentials received from the user. Some verified customers may have customer information matching all of the credentials received from the user, for example, those verified customers who take the same course at the same university as the user. Some verified customers may have customer information matching less than all of the credentials received from the user, for example, those already-verified customers who do not take the same course as the user, but attend the same university as the user.

The method 300 proceeds to step 314, where the method 300 displays the matching entries from the master database to a user via a graphical user interface (GUI). The method 300 distinguishes entries that match all of the credentials received from the user from the entries that match less than all of the credential received from the user. In some embodiments, the method 300 displays the entries in separate lists. In some embodiments, the method 300 provides a visual marking that distinguishes the entries matching all of the criteria, for example with highlighting, check marks, or any other indication that can visually distinguish the entries. The method 300 may also display a message to the user indicating the number of references from each set of entries that are required for eligibility verification.

The method 300 proceeds to step 316, where the method 300 receives a selection of the entries representing community members from whom a reference may be requested. In some embodiments, the method 300 receives input from a user who selects a plurality of entries of community members from whom the user wishes to request a reference. In some embodiments, the method 300 automatically selects a predefined number of entries representing community members. The method 300 sends each selected community member an email requesting a reference confirmation. The method 300 retrieves an email address for each selected community member from the master database, and generates and sends an email to each selected community member. In some embodiments, the method 300 includes a reference confirmation link in each email such that the recipient of the email may easily provide a reference for the user by merely selecting the reference confirmation link. In other embodiments, other methods of reference confirmation may be used.

The method 300 proceeds to step 318, where the method 300 determines whether the method 300 can validate the user. The method 300 determines whether a required number of reference confirmations for the user has been received. The method 300 may wait a predefined amount of time to receive reference confirmations, for example an hour or a day. If the method 300 determines than the required number of reference confirmations are not received for the user, the method 300 proceeds to step 312 where the user may select other community members to provide references and iterates until at step 318, the required number of reference confirmations are received.

When, at step 318, the method 300 determines the user is validated, meaning a required number of reference confirmations are received, the method 300 proceeds to step 320. At step 320, the method 300 adds the user to the master database of verified customers and facilitates providing the user with a fully operational, non-trial version of the price-differentiated offering. In some embodiments, the method 300 updates a subscription database in order to remove the trial version from the user's subscription and provide entitlement to the fully operational version. In some embodiments, the method 300 sends notification to a subscription server to update the user's subscription accordingly.

Hence, a user is automatically verified using community validation at a low cost and without third-party verification service involvement. The method 300 proceeds to step 322 and ends.

The embodiments of the present invention may be embodied as methods, apparatus, electronic devices, and/or computer program products. Accordingly, the embodiments of the present invention may be embodied in hardware and/or in software (including firmware, resident software, micro-code, etc.), which may be generally referred to herein as a “circuit” or “module”. Furthermore, the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device. These computer program instructions may also be stored in a computer-usable or computer-readable memory that may direct a computer or other programmable data processing apparatus to function in a particular manner, such that the instructions stored in the computer usable or computer-readable memory produce an article of manufacture including instructions that implement the function specified in the flowchart and/or block diagram block or blocks.

The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium include the following: hard disks, optical storage devices, a transmission media such as those supporting the Internet or an intranet, magnetic storage devices, an electrical connection having one or more wires, a portable computer diskette, a random access memory (RAM), a read-only memory (ROM), an erasable programmable read-only memory (EPROM or Flash memory), an optical fiber, and a compact disc read-only memory (CD-ROM).

Computer program code for carrying out operations of the present invention may be written in an object oriented programming language, such as Java®, Smalltalk or C++, and the like. However, the computer program code for carrying out operations of the present invention may also be written in conventional procedural programming languages, such as the “C” programming language and/or any other lower level assembler languages. It will be further appreciated that the functionality of any or all of the program modules may also be implemented using discrete hardware components, one or more Application Specific Integrated Circuits (ASICs), or programmed Digital Signal Processors or microcontrollers.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the present disclosure and its practical applications, to thereby enable others skilled in the art to best utilize the invention and various embodiments with various modifications as may be suited to the particular use contemplated.

The methods described herein may be implemented in software, hardware, or a combination thereof, in different embodiments. In addition, the order of methods may be changed, and various elements may be added, reordered, combined, omitted, modified, etc. All examples described herein are presented in a non-limiting manner. Various modifications and changes may be made as would be obvious to a person skilled in the art having benefit of this disclosure. Realizations in accordance with embodiments have been described in the context of particular embodiments. These embodiments are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the example configurations may be implemented as a combined structure or component. These and other variations, modifications, additions, and improvements may fall within the scope of embodiments as defined in the claims that follow.

While the foregoing is directed to embodiments of the present invention, other and further embodiments of the invention may be devised without departing from the basic scope thereof, and the scope thereof is determined by the claims that follow.

1. A computer implemented method comprising:
receiving credentials to verify eligibility of a user as a member of a group;
matching the credentials to member information of a plurality of verified members of the group;
requesting a reference from a plurality of matched verified members of the group, verifying that the user is eligible to be a member of the group; and
validating the user as a member of the group upon receipt of at least one of the requested references.

2. The method of claim 1, further comprising:
receiving, from a user, a request to purchase a software product at a special group discount;
providing a trial version of the software product;
validating the user as a member of the group; and
providing a fully operational version of the software product when the user is validated as a member of the group.

3. The method of claim 1, wherein matching credentials comprises:
retrieving a list of a plurality of verified members who have member information that matches all of the received credentials;
retrieving a list of a plurality of verified members who have member information that matches at least one but less than all of the received credentials; and
receiving a selection of a plurality of verified members from each list, wherein the selected verified members are selected to provide a reference for the user.

4. The method of claim 1, wherein requesting verification comprises:
sending an email to the one or more matched verified members, wherein the email comprises a reference confirmation link that verifies the user as eligible to be a member of the group.

5. The method of claim 1, wherein validating requires receiving a predefined number of references from the matched verified members of the group.

6. The method of claim 1, wherein the verified members are stored in a database, wherein each entry in the database comprises an email address for the verified member and credentials used to verify the verified member.

7. The method of claim 1, further comprising adding the user to a database of verified users upon successful validation of the user as a member of the group.

8. An apparatus for providing subscriber eligibility verification using community validation comprising:
a computer having one or more processors in a memory and further comprising:
a verification module for receiving credentials to verify a user as eligible to be a member of a group and matching the credentials to member information of a plurality of verified members of the group;
an email module for requesting a reference from a plurality of matched verified members of the group, verifying that the user is eligible to be a member of the group;
an approval tracker for validating the user as a member of the group upon receipt of at least one of the requested references; and
a master database for storing the plurality of verified members.

9. The apparatus of claim 8, where the verification module further:
receives, from a user, a request to purchase a software product at a special group discount;
provides a trial version of the software product;
validates the user as a member of the group;
adds the user to the plurality of verified members of the group; and
provides a fully operational version of the software product when the user is validated as eligible to be a member of the group.

10. The apparatus of claim 8, wherein the verification module matches credentials by:
retrieving a list of a plurality of verified members who have member information that matches all of the received credentials;
retrieving a list of a plurality of verified members who have member information that matches at least one but less than all of the received credentials; and
receiving a selection of a plurality of verified members from each list, wherein the selected verified members are selected to provide a reference for the user.

11. The apparatus of claim 8, wherein the email module requests verification by:
sending an email to the one or more matched verified members, wherein the email comprises a reference confirmation link that verifies the user as eligible to be a member of the group.

12. The apparatus of claim 8, wherein the approval tracker validates by requiring receipt of a predefined number of references from the matched verified members of the group.

13. The apparatus of claim 8, wherein each entry in the master database comprises an email address for the verified member and credentials used to verify the verified member.

14. A non-transient computer readable medium for storing computer instructions that, when executed by at least one processor causes the at least one processor to perform a method for providing subscriber eligibility verification using community validation comprising:
receiving credentials to verify a user as eligible to be a member of a group;
matching the credentials to member information of a plurality of verified members of the group;
requesting a reference from a plurality of matched verified members of the group, verifying that the user is eligible to be a member of the group; and
validating the user as a member of the group upon receipt of at least one of the requested references.

15. The computer readable medium of claim 14, further comprising:
receiving, from a user, a request to purchase a software product at a special group discount;
providing a trial version of the software product;
validating the user as a member of the group; and
providing a fully operational version of the software product when the user is validated as a member of the group.

16. The computer readable medium of claim 14, wherein matching credentials comprises:
retrieving a list of a plurality of verified members who have member information that matches all of the received credentials;
retrieving a list of a plurality of verified members who have member information that matches at least one but less than all of the received credentials; and
receiving a selection of a plurality of verified members from each list, wherein the selected verified members are selected to provide a reference for the user.

17. The computer readable medium of claim 14, wherein requesting verification comprises:
sending an email to the one or more matched verified members, wherein the email comprises a reference confirmation link that verifies the user as eligible to be a member of the group.

18. The computer readable medium of claim 14, wherein validating requires receiving a predefined number of references from the matched verified members of the group.

19. The computer readable medium of claim 14, wherein the verified members are stored in a database, wherein each entry in the database comprises an email address for the verified member and credentials used to verify the verified member.

20. The computer readable medium of claim 14, further comprising adding the user to a database of verified users upon successful validation of the user as a member of the group.
